(19) United States
(12) Patent Application Publication
(10) Pub. No.: US 2011/0074354 A1
(43) Pub. Date: Mar. 31, 2011

(54) CAR POWER SOURCE APPARATUS, AND CAPACITY EQUALIZING METHOD FOR THE CAR POWER SOURCE APPARATUS

(76) Inventor: Junya YANO, Kasai-shi (JP)

(21) Appl. No.: 12/892,241

(22) Filed: Sep. 28, 2010

(30) Foreign Application Priority Data
Sep. 28, 2009 (JP) 2009-222576

(51) Int. Cl. H02J 7/00

(52) U.S. Cl. 320/116; 180/65.29

(57) ABSTRACT

The power source apparatus is provided with a unit switch 16 connected in series with each battery unit 10, cell capacity equalizing circuits 20 to suppress variation in the remaining capacities of the battery cells 11 that make up each battery unit 10 based on the cell voltages, unit voltage detection circuits 45 to detect unit voltage that is the overall voltage of a battery unit 10, unit capacity equalizing circuits 40 to suppress variation in the remaining capacities of the battery units 10 based on the unit voltages detected by the unit voltage detection circuits 45, and a power source controller 30 that controls the cell capacity equalizing circuits 20 to equalize battery cell 11 remaining capacities in each battery unit 11 and subsequently controls the unit capacity equalizing circuits 40 to equalize battery unit 10 remaining capacities over the entire battery block 15.

### BACKGROUND OF THE INVENTION

1. Field of the Invention

The present invention relates to a car power source apparatus with many batteries connected in series to increase output voltage, and to a capacity equalizing method for the car power source apparatus.

2. Description of the Related Art

To achieve high output, a car power source apparatus has many batteries connected in series to increase the voltage. In this power source apparatus, each of the series-connected batteries is charged by the same charging current and discharged by the same discharging current. Therefore, if all the batteries have exactly the same electrical characteristics, battery voltage and remaining capacity non-uniformity will not occur. However, in actuality, batteries cannot be made with exactly the same electrical characteristics. When charging and discharging is performed repeatedly, disparity in battery electrical characteristics results in voltage and remaining capacity non-uniformities. Further, battery voltage non-uniformity can cause over-charging or over-discharging of a particular battery. To avoid this detrimental effect, a car power source apparatus has been developed that detects the voltage of each battery and eliminates non-uniformities. (Refer to Japanese Laid-Open Patent Publication 2004-31013 and 2004-229391.)

As shown in FIG. 8, the car power source apparatus cited in JP 2004-31013-A has a plurality of parallel blocks 81a-81d connected in series as a battery block. When battery block charging capacity is adjusted at the parallel block level, the cell open-circuit voltage of each parallel block is detected by a cell voltage detection section 83. A depth-of-discharge corresponding to the cell open-circuit voltage for each parallel block is read from pre-stored data representing the depth-of-discharge versus cell open-circuit voltage characteristics. If a parallel block has a depth-of-discharge at or below a set value, battery block capacity adjustment at the parallel block level is prohibited. A necessary prerequisite for use of this method is that parallel-connected battery cells are in-turn connected in series.

However, practical configurations also include many battery cells connected in series to form battery units that are in-turn connected in parallel, and the previously described method cannot be applied to this connection scheme. As shown in FIG. 9 for a car power source apparatus with battery units 10 connected in parallel, when equalization is performed between battery cells 11 in each battery unit 10, there can be voltage differences between the individual parallel-connected battery units 10. In this case, when the switch SW connecting each battery unit 10 is closed at the start of vehicle operation, surge currents can flow in response to voltage differences from the high voltage battery units 10 to the lower voltage battery units 10. In particular, since connection resistance between battery units 10 is low, there is a tendency for the surge currents to be high. With these high surge currents, detrimental effects on the switches and battery cells are a concern.

The present invention was developed with the object of correcting these types of prior art drawbacks. Thus, it is a primary object of the present invention to provide a car power source apparatus, and capacity equalizing method for the car power source apparatus with a plurality of battery cells connected in series to form battery units and a plurality of battery units in-turn connected in parallel to form a battery block that can effectively eliminate non-uniformity between battery units.

### SUMMARY OF THE INVENTION

To achieve the object stated above, a car power source apparatus for the first aspect of the present invention can be provided with a plurality of battery units having a plurality of series-connected battery cells, a battery block having a plurality of battery units connected in parallel, a unit switch connected in series with each battery unit, cell voltage detection circuits to detect the cell voltages of the battery cells that make up each battery unit, cell capacity equalizing circuits to suppress variation in the remaining capacities of the battery cells that make up each battery unit based on the cell voltages detected by the cell voltage detection circuits, unit voltage detection circuits to detect unit voltage that is the overall voltage of a battery unit, unit capacity equalizing circuits to suppress variation in the remaining capacities of the battery units based on the unit voltages detected by the unit voltage detection circuits, and a power source controller that controls the cell capacity equalizing circuits to equalize battery cell remaining capacities in each battery unit and subsequently controls the unit capacity equalizing circuits to equalize battery unit remaining capacities over the entire battery block. Accordingly, in a battery block with battery units having series-connected battery cells and with those battery units in-turn connected in parallel, non-uniformities in battery cell remaining capacities and non-uniformities in battery unit remaining capacities can be eliminated.

A car power source apparatus for the second aspect of the present invention can be configured to allow the power source controller to receive a start signal from the vehicle-side. When the power source controller detects the start signal from the vehicle-side showing an inactive state, each unit switch is turned OFF and battery cells within each battery unit are equalized by the cell capacity equalizing circuits. As a result, equalization is established at the battery cell level, unit remaining capacity equalization can be independently performed on each battery unit, and the flow of high surge currents in some battery cells at unit equalization can be avoided.

In a power source apparatus for the third aspect of the present invention, the power source controller can determine if equalization among the battery cells in each battery unit is necessary based on the battery cell voltages detected by the cell voltage detection circuits. For a battery unit judged to require equalization, the power source controller can issue a cell remaining capacity equalization instruction to the cell capacity equalizing circuit of the applicable battery unit to equalize the remaining capacities of the battery cells in that battery unit. As a result, battery units requiring cell remaining capacity equalization can be selected, and suitable cell remaining capacity equalization can be performed for the applicable battery units.

In a power source apparatus for the fourth aspect of the present invention, when completion of cell remaining capacity equalization is detected, the power source controller can determine if equalization among the battery units is necessary based on the battery unit voltages detected by the unit voltage detection circuits. For battery units judged to require equalization, the power source controller can issue unit remaining capacity equalization instructions to the unit capacity equalizing circuits of the applicable battery units to equalize remaining battery capacities among the battery units. As a result, a plurality of battery units requiring unit remaining capacity equalization can be selected, and suitable unit remaining capacity equalization can be performed for the applicable battery units.

In a power source apparatus for the fifth aspect of the present invention, the power source controller can detect completion of cell remaining capacity equalization by receiving of an equalization-completed signal from the applicable battery unit. As a result, the time at completion of cell remaining capacity equalization can be reliably communicated to the power source controller.

In a power source apparatus for the sixth aspect of the present invention, the power source controller can detect completion of cell remaining capacity equalization based on the battery cell voltages detected by the cell voltage detection circuit. As a result, the time at completion of cell remaining capacity equalization can be appropriately recognized by the power source controller.

In a power source apparatus for the seventh aspect of the present invention, the power source controller can detect completion of unit remaining capacity equalization based on the battery unit voltages detected by the unit voltage detection circuit in each battery unit. As a result, the time at completion of unit remaining capacity equalization can be appropriately recognized by the power source controller.

A car power source apparatus for the eighth aspect of the present invention can be provided with battery block power output terminals, and an output switch connected between the power output terminals and the battery block. When the power source controller receives a key-OFF signal from the vehicle-side, the power source controller can turn the output switch OFF and leave the unit switches ON for a given time period. After the given time period, the power source controller can turn the unit switches OFF. Accordingly, since the series connected batteries are allowed to be connected in parallel for a given time period, unit remaining capacity equalization can take place during that time interval. By performing this operation at the end of driving each time the vehicle is operated, equalization among battery units can be consistently maintained.

In a power source apparatus for the ninth aspect of the present invention, the start signal can be the key-ON signal.

In a capacity equalizing method for the car power source apparatus for the eleventh aspect of the present invention, the car power source apparatus is provided with a plurality of battery units having a plurality of series-connected battery cells; a battery block having a plurality of battery units connected in parallel; cell voltage detection circuits to detect the cell voltages of the battery cells that make up each battery unit; a unit switch connected in series with each battery unit; unit voltage detection circuits to detect the overall unit voltage of a battery unit; cell capacity equalizing circuits to suppress disparity in the remaining capacities of battery cells that make up each battery unit; unit capacity equalizing circuits to suppress disparity in the remaining capacities of the battery units; and a power source controller that can receive signals from the vehicle-side, controls the cell capacity equalizing circuits to equalize battery cell remaining capacities in each battery unit, and controls the unit capacity equalizing circuits to equalize battery unit remaining capacities over the entire battery block. The capacity equalizing method can include a step to determine if the start signal from the vehicle-side indicates an inactive state, a step to turn all the unit switches OFF when the start signal indicates an inactive state, a step for the power source controller to determine if equalization of the battery cells is necessary in each battery unit based on battery cell voltages detected by the cell voltage detection circuits, a step for applicable cell capacity equalizing circuits to equalize the remaining capacity of each battery cell within the applicable battery units when equalization is determined necessary, a step for the power source controller to determine if cell remaining capacity equalization has been completed for all applicable battery units, a step for the power source controller to determine if equalization between battery units is necessary based on battery unit voltages detected by the unit voltage detection circuits when completion of cell remaining capacity equalization is determined, and a step for applicable unit capacity equalizing circuits to equalize remaining battery capacity between applicable battery units when equalization is determined necessary.

As a result, appropriate cell remaining capacity equalization and unit remaining capacity equalization can be performed for battery units that require cell remaining capacity equalization and for battery units that require unit remaining capacity equalization. Further, when equalization is performed, the flow of excessive surge current in the battery cells can be avoided.

A capacity equalizing method for the car power source apparatus for the twelfth aspect of the present invention can include a step when the power source controller receives a key-OFF signal from the vehicle-side, the power source controller turns the output switch connected between the power output terminals and the battery block OFF while leaving the unit switches in the ON state for a given time period, and subsequently turns the unit switches OFF after the given time interval. Accordingly, since the series connected batteries are allowed to be connected in parallel for a given time period, unit remaining capacity equalization can take place during that time interval. By performing this operation at the end of driving each time the vehicle is operated, equalization among battery units can be consistently maintained.

The above and further objects of the present invention as well as the features thereof will become more apparent from the following detailed description to be made in conjunction with the accompanying drawings.

### BRIEF DESCRIPTION OF THE DRAWINGS

FIG. 1 is a block diagram showing an embodiment of the car power source apparatus;

FIG. 2 is a circuit diagram showing an example of a cell capacity equalizing circuit;

FIG. 3 is a circuit diagram showing a unit capacity equalizing circuit example;

FIG. 4 is a block diagram showing an alternative embodiment of the car power source apparatus;

FIG. 5 is a flowchart showing an example of a capacity equalizing method;

FIG. 6 is a block diagram showing an example of the power source apparatus installed on-board a hybrid car driven by both an engine and an electric motor;

FIG. 7 is a block diagram showing an example of the power source apparatus installed on-board an electric automobile (electric vehicle) driven only by an electric motor;

FIG. 8 is a block diagram showing a prior art car power source apparatus having series-connected battery units;

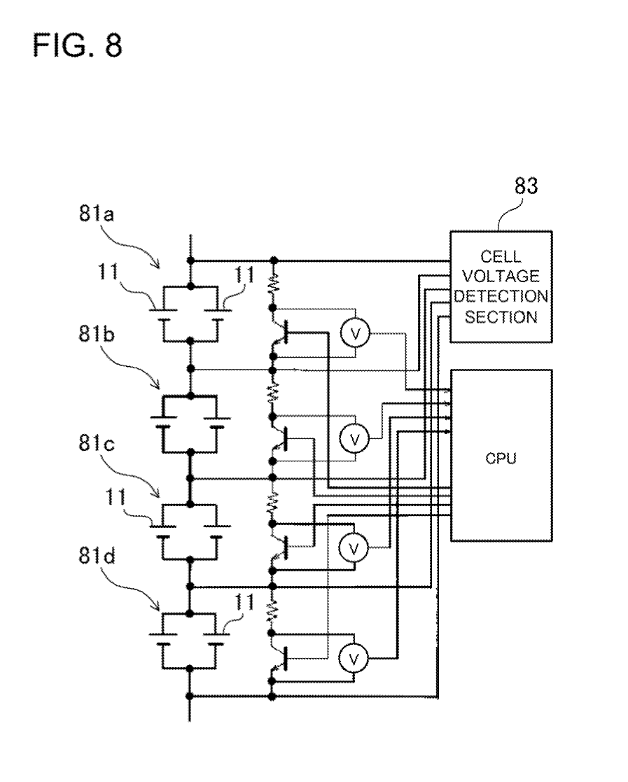

FIG. 9 is a block diagram showing a car power source apparatus having battery units connected in parallel;

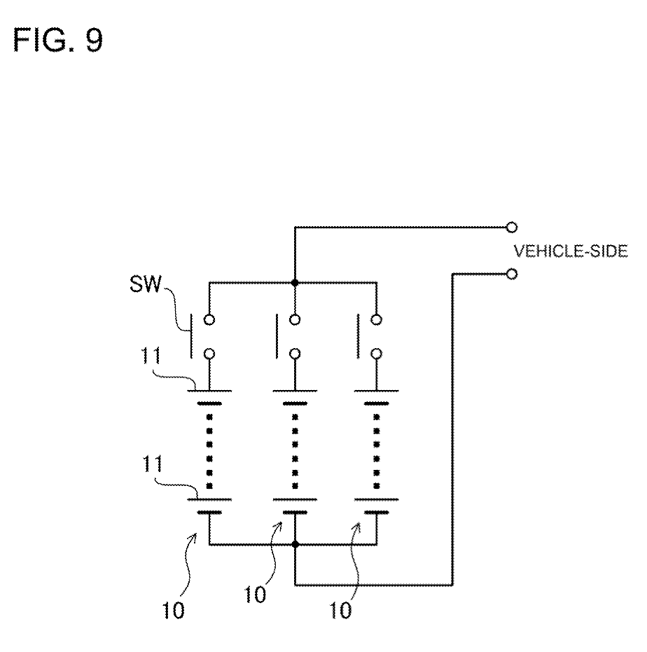

### DETAILED DESCRIPTION OF THE EMBODIMENT(S)

The following describes embodiments of the present invention based on the figures.

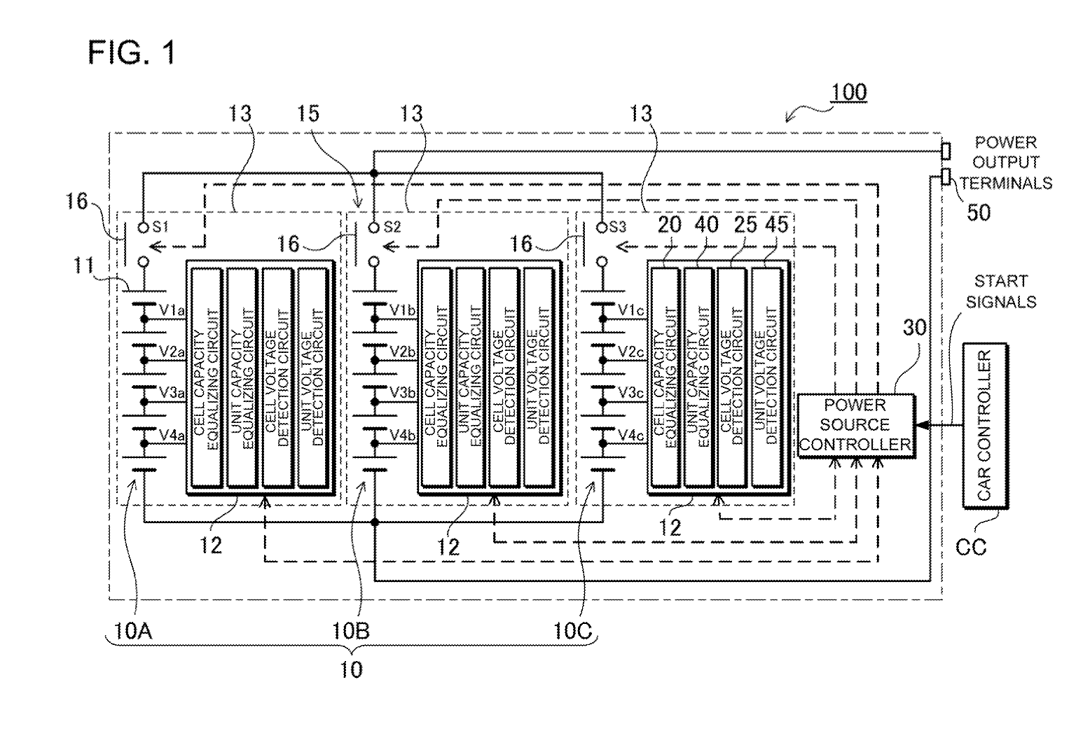

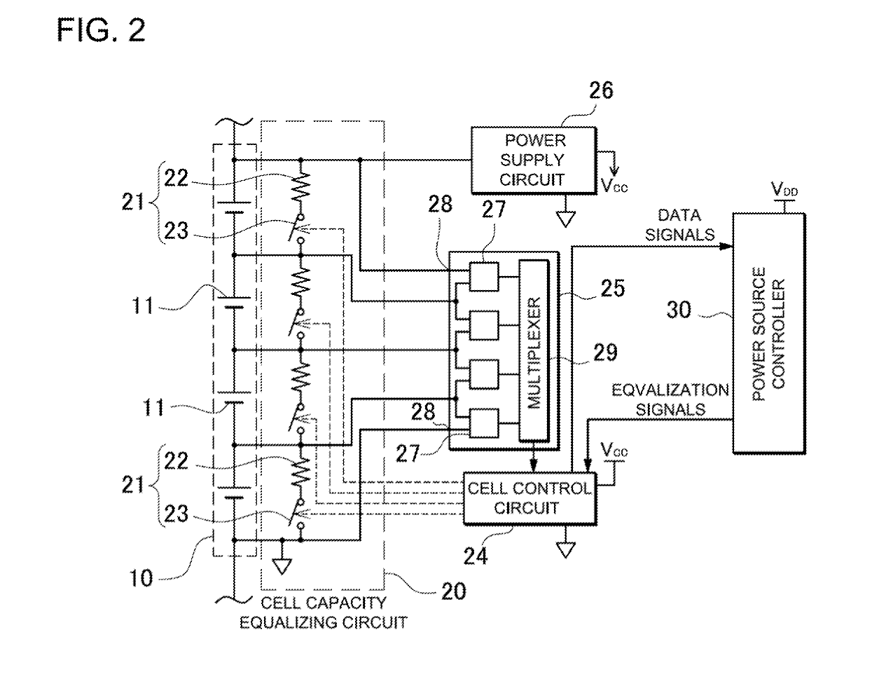

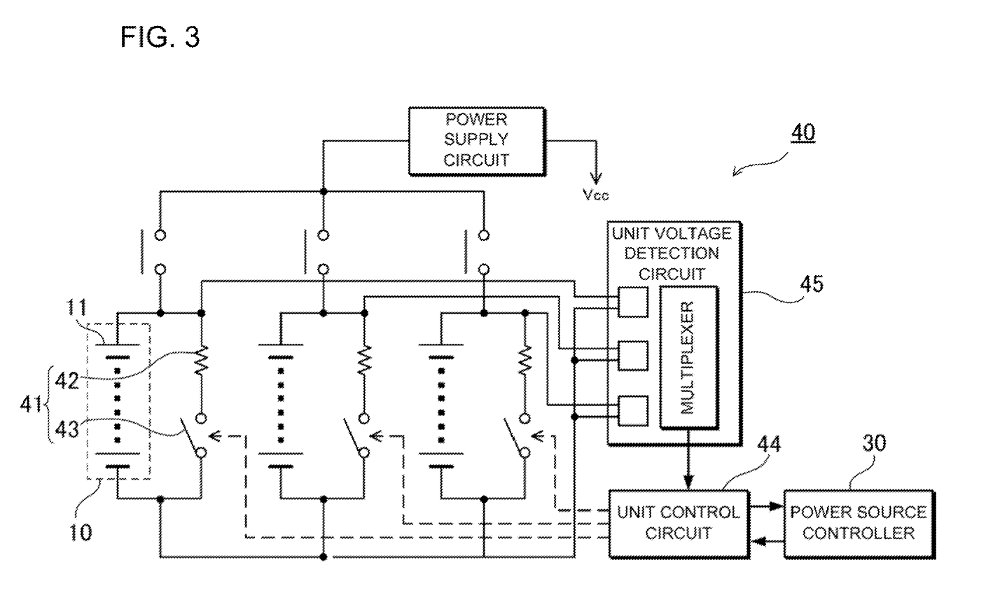

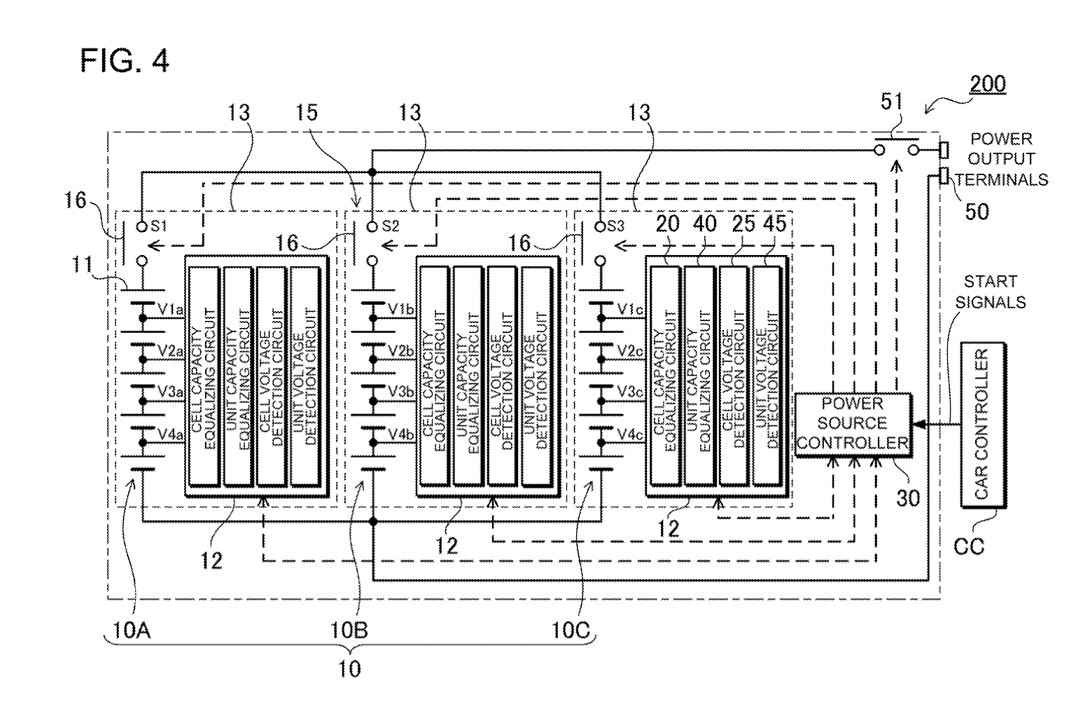

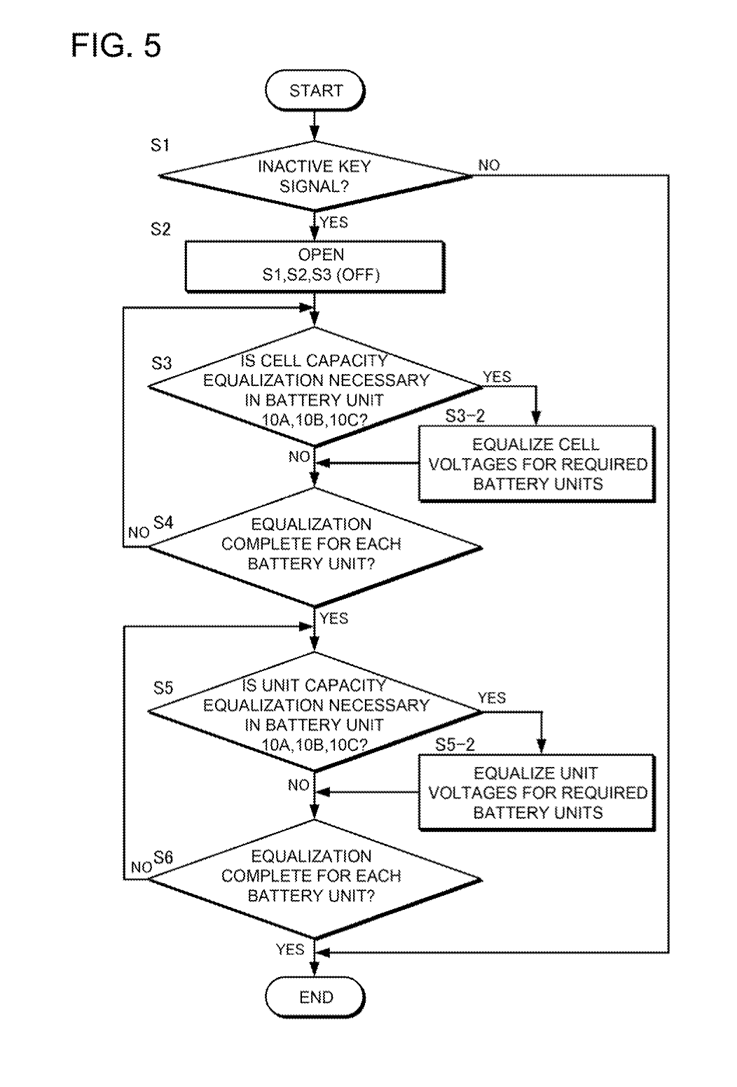

An embodiment of a car power source apparatus and capacity equalizing method is described based on FIGS. 1-5. FIG. 1 shows a block diagram of an embodiment of a power source apparatus, FIG. 2 shows a circuit diagram of an example of a cell capacity equalizing circuit, FIG. 3 shows a circuit diagram for a unit capacity equalizing circuit example of, FIG. 4 shows a block diagram of an alternative embodiment of a power source apparatus, and FIG. 5 shows a flowchart of an example of a capacity equalizing method. The car power source apparatus 100 shown in these figures has battery units 10 with a plurality of battery cells 11 that can be charged connected in series to supply power to an electric motor that drives the vehicle. The battery units 10 are configured with a circuit module 12 connected in parallel with each battery unit 10 to farm battery array elements 13. Further, the power source apparatus 100 has a battery block 15 formed by connecting a plurality of the battery array element 13 battery units 10 in parallel, and a unit switch 16 is connected in series with each battery unit 10. By selectively turning the unit switches 160N or OFF, it is possible to disconnect each individual battery unit 10 from the battery block 15. Suitable circuit breakers and relays (contactors) can be used as the unit switches 16.

Further, the power source apparatus 100 is provided with a power source controller 30 to control the power source apparatus 100, and battery block 15 power output terminals 50. The power source controller 30 can receive vehicle key signals from the vehicle-side car controller CC, and can selectively control each circuit module 12 for equalization based on signals from the car controller CC. This power source apparatus 100 makes up the battery system that supplies power to an electric motor that drives the vehicle, and that power is supplied from the power output terminals 50.

### [Circuit Modules 12]

Each circuit module 12 is provided with a cell voltage detection circuit 25 to detect the cell voltages of the battery cells 11 that make up the battery unit 10, a unit voltage detection circuit 45 to detect the overall voltage of the battery unit 10, a cell capacity equalizing circuit 20 to suppress variation in the remaining capacities of battery cells 11 that make up the battery unit 10, and a unit capacity equalizing circuit 40 to suppress variation in the remaining capacities of the battery units 10,

### [Battery Block 15]

A plurality of individual secondary (rechargeable) battery cells 11, which can be charged and discharged, can be connected in series and parallel and used as a battery block 15. Batteries such as lithium-ion batteries, nickel-hydride batteries, and nickel-cadmium batteries can be appropriately used as the rechargeable batteries.

### [Cell Capacity Equalizing Circuit 20]

Each cell capacity equalizing circuit 20 equalizes battery cell 11 voltages to eliminate non-uniformities. A circuit diagram of one example of a cell capacity equalizing circuit 20 is shown in FIG. 2. Here, only one of the three cell capacity equalizing circuits 20 is shown and described below. This cell capacity equalizing circuit 20 discharges high voltage battery cells 11 through cell discharging resistors 22 to eliminate non-uniformities. However, the cell capacity equalizing circuit of the present invention is not limited specifically to a circuit that discharges battery cells through cell discharging resistors. For example, a cell capacity equalizing circuit could also discharge high voltage battery cells into a charge storage device such as a capacitor or battery, and discharge the charge stored in that charge storage device to low voltage battery cells to eliminate battery voltage differences.

The cell capacity equalizing circuit 20 of FIG. 2 is provided with cell discharge circuits 21 having cell switching devices 23 connected in series with the cell discharging resistors 22. The cell capacity equalizing circuit 20 has a cell control circuit 24 to control each cell switching device 230N and OFF, and a cell voltage detection circuit 25 connected to detect the voltage of each battery cell 11. The cell discharging resistor 22 and cell switching device 23 of each cell discharge circuit 21 are connected in parallel with each battery cell 11. In this cell capacity equalizing circuit 20, when the voltage of a battery cell 11 becomes high, the cell control circuit 24 switches the cell switching device 23 ON to discharge the battery cell 11 through the cell discharging resistor 22 to reduce the battery cell 11 voltage and equalize battery cells 11.

Further, the cell capacity equalizing circuit 20 operates via power supplied from the battery unit 10. The cell capacity equalizing circuit 20 of the figure operates off output voltage (Vcc) from a power supply circuit 26 that receives power from the battery unit 10. For example, battery unit 10 voltage can be stepped-down by a power supply circuit 26 that is a direct-current-to-direct-current (DC-DC) converter to supply power to the cell capacity equalizing circuit 20. With this circuit configuration, proper operating voltage can be supplied to the cell capacity equalizing circuit 20 even when battery unit 10 voltage is high.

The cell voltage detection circuit 25 has input terminals 28 of voltage detection sub-circuits 27 connected to each battery cell 11 to detect the voltage of each battery cell 11. However, a plurality of battery cell voltages can also be detected with a single voltage detection sub-circuit by providing a switching circuit (not illustrated) at the input-side of the voltage detection sub-circuit to switch the connected battery cell. Output signals from the voltage detection sub-circuits 27 are multiplexed by a multiplexer 29 and input to the cell control circuit 24. The multiplexer 29 consecutively switches the output from each voltage detection sub-circuit 27 into the cell control circuit 24.

The cell control circuit 24 compares the voltages of the individual battery cells 11, and controls the cell switching devices 23 to equalize the voltages of all the battery cells 11. For a battery cell 11 with too high a cell voltage, the cell control circuit 24 switches the cell discharge circuit 21 cell switching device 230N to discharge that battery cell 11. Battery cell 11 voltage decreases with discharging. When the battery cell 11 voltage decreases and becomes equal to the voltage of the other battery cells 11, the cell switching device 23 is switched from ON to OFF. When the cell switching device 23 is turned OFF, discharge of that battery cell 11 stops. In this manner, the cell control circuit 24 discharges high voltage battery cells 11 to equalize the cell voltages of all the battery cells 11.

### [Unit Capacity Equalizing Circuit 40]

A cell capacity equalizing circuit 20 as shown in FIG. 2 is provided for each of the three battery units 10A, 106, 10C in the power source apparatus of FIG. 1 to equalize the battery cells 11 in each battery unit 10A, 10B, 10C. Meanwhile, unit capacity equalizing circuits 40 are provided to eliminate non-uniformities between the battery units 10. FIG. 3 shows a unit capacity equalizing circuit 40 example. Here, the three unit capacity equalizing circuits 40 and unit voltage detection circuits 45 shown as circuit module 12 components associated with the three battery units 10A, 108, 10C in FIG. 1 are alternately depicted as single distributed circuits in FIG. 3. The unit capacity equalizing circuit 40 shown in FIG. 3 has a unit voltage detection circuit 45 and a unit control circuit 44 connected to the battery block 15. Further, the unit capacity equalizing circuit 40 is provided with unit discharge circuits 41 having a series-connected unit discharging resistor 42 and unit switching device 43 connected in parallel with each battery unit 10. The battery units 10 can be equalized via these unit discharge circuits 41. The total unit voltage is detected for each battery unit 10, and the unit switching devices 43 of the unit discharge circuits 41 are controlled ON and OFF by the unit control circuit 44. The unit voltage of each battery unit 10 is detected by the unit voltage detection circuit 45, and the unit control circuit 44 switches ON the switching device 43 of unit discharge circuits 41 connected to battery units 10 with high unit voltage to discharge those battery units 10 and equalize the battery units 10.

Further, the power source apparatus of FIG. 1 is provided with a power source controller 30 that controls cell remaining capacity equalization by the cell capacity equalizing circuits 20 and unit remaining capacity equalization by the unit capacity equalizing circuits 40. The cell capacity equalizing circuits 20 begin equalizing cell remaining capacities in each battery unit 10 upon receipt of a cell remaining capacity equalization signal input from the power source controller 30. When cell remaining capacity equalization has been completed for all the battery units 10, next a unit remaining capacity equalization signal is issued from the power source controller 30 to the unit capacity equalizing circuits 40 to begin equalizing remaining capacity between the battery units 10. The power source controller 30 sets the timing for battery block 15 equalization by the cell capacity equalizing circuits 20 based on vehicle operating conditions and the state of the ignition switch. When it is time for the cell capacity equalizing circuits 20 to perform cell remaining capacity equalization, the power source controller 30 issues a cell remaining capacity equalization signal to the cell capacity equalizing circuits 20. Conversely, when it is time for the unit capacity equalizing circuits 40 to perform unit remaining capacity equalization, the power source controller 30 issues a unit remaining capacity equalization signal to the unit capacity equalizing circuits 40.

For example, the power source controller 30 detects that the ignition switch is OFF and the vehicle is stopped to output a cell remaining capacity equalization signal to the cell capacity equalizing circuits 20. The ignition switch can be detected in the OFF state by receipt of a key-OFF signal from the vehicle-side car controller CC. Alternatively, the system can be configured to detect a start signal indicating an inactive state. Further, when cell remaining capacity equalization is performed, the unit switches 16 for all the battery units 10 are turned OFF. As a result, cell remaining capacity equalization can be performed independently within each battery unit 10, and in particular, when equalization between battery units is performed after cell remaining capacity equalization, high surge current flow into low voltage battery units can be avoided.

### (Power Source Controller 30)

As described above, the power source controller 30 issues cell remaining capacity equalization signals to the cell capacity equalizing circuits 20 and unit remaining capacity equalization signals to the unit capacity equalizing circuits 40 according to a specified timing scheme. In addition to recurring time events such as ignition switch key-OFF and key-ON events, equalization operations can also performed at random times when equalization is judged to be necessary. For example, the necessity for equalization between battery cells 11 can be judged for each battery unit 10 based on the cell voltages detected by each cell voltage detection circuit 25. A cell remaining capacity equalization directive to equalize remaining capacity between battery cells 11 is issued only to the cell capacity equalizing circuits 20 of battery units 10 judged to require equalization. Accordingly, only the battery units 10 that require cell remaining capacity equalization are equalized at times when that equalization becomes necessary.

After cell remaining capacity equalization has been completed, the power source controller 30 can conduct unit remaining capacity equalization. In this case as well, the system configuration is not limited to performing unit remaining capacity equalization on all the battery units 10. For example, the necessity for unit equalization can be judged based on the unit voltage detected by the unit voltage detection circuit 45 for each battery unit. A unit remaining capacity equalization directive is issued only to the unit capacity equalizing circuits of battery units judged to require equalization. Further, the power source controller can also be configured to receive equalization-completed signals to detect completion of cell remaining capacity equalization for applicable battery units. For example, a cell voltage detection circuit or cell capacity equalizing circuit can issue an equalization-completed signal to the power source controller. Or, completion of cell remaining capacity equalization can be judged at the power source controller based on the cell voltages detected by the cell voltage detection circuits. In addition, it is also possible for the power source controller to judge completion of unit remaining capacity equalization based on the unit voltage detected by the unit voltage detection circuit 45 for each battery unit.

The power source apparatus can also be provided with a charging and discharging controller (not illustrated) to control battery block 15 charging and discharging, a current detector (not illustrated) to detect charging and discharging current flow in the battery block 15, a battery capacity computation section (not illustrated) to calculate battery block 15 remaining capacity based on the charging and discharging current detected by the current detector, and a power source-side communication section (not illustrated) to send charging and discharging current limits based on battery block 15 remaining capacity calculated by the battery capacity computation section to the vehicle-side that is being supplied with power. In the example of FIG. 1, the power source controller 30 is powered by vehicle electrical system storage (auxiliary) battery.

The power output terminals 50 are connected to power input terminals on the vehicle-side to supply power from the battery block 15 to the vehicle-side. Further, as shown in the alternative embodiment car power source apparatus 200 of FIG. 4, an output switch 51 can be provided between the power output terminals 50 and the battery block 15. For this case, at the completion of vehicle operation when the power source controller 30 receives a key-OFF signal from the car controller CC, the power source controller 30 turns the output switch 51 OFF and leaves the unit switches 16 ON for a set time period. Since the series-connected battery units are connected in parallel under these conditions, unit remaining capacity equalization can take place among the battery units. In particular, by performing this operation each time vehicle driving is completed, equalization between battery units can be consistently maintained.

The procedure for car power source apparatus cell remaining capacity equalization and unit remaining capacity equalization is described based on the flowchart of FIG. 5. First in step S1, the start signal from the vehicle-side is judged to determine if it indicates an inactive state. In the example of FIG. 1, an inactive state can be judged by the power source controller 30 receiving a key-OFF signal from the car controller CC. For a state that is not inactive, namely for a key-ON state, the power source apparatus procedure is terminated.

If the start signal is judged to indicate an inactive state, control proceeds to step S2 and the power source controller 30 turns all the unit switches 16 OFF. Next, control proceeds to step S3 and the power source controller 30 judges if equalization between battery cells is necessary for each battery unit based on the cell voltages detected by the cell voltage detection circuits 25. If equalization is judged unnecessary, control proceeds directly to step S4. Otherwise, if cell remaining capacity equalization is judged necessary, control proceeds to step S3-2. In step S3-2, the cell capacity equalizing circuit 20 of a battery unit 10 judged to require cell remaining capacity equalization performs equalization between battery cells within the applicable battery unit 10. Next, control proceeds to step S4 and the power source controller 30 judges if cell remaining capacity equalization has been completed for all applicable battery units 10. If cell remaining capacity equalization has not been completed, control returns to repeat step S3. When cell remaining capacity equalization is judged to be complete for all the battery units 10, control proceeds to step S5.

Next in step S5, the power source controller 30 judges if equalization between battery units is necessary based on the battery unit voltages detected by the unit voltage detection circuits 45. If equalization is judged unnecessary, control proceeds directly to step S6. Otherwise, if unit remaining capacity equalization is judged necessary, control proceeds to step S5-2, in step S5-2, the unit capacity equalizing circuit 40 for the applicable battery unit 10 performs unit remaining capacity equalization among the battery units 10 and subsequently control proceeds to step S6.

Finally in step S6, the power source controller 30 judges if unit remaining capacity equalization has been completed for all battery units 10. If unit remaining capacity equalization has not been completed, control returns to repeat step S5. When unit remaining capacity equalization is judged to be complete for all the battery units 10, the power source apparatus procedure is terminated. In this manner, cell remaining capacity equalization and unit remaining capacity equalization are successively executed to eliminate all non-uniformities.

The power source apparatus described above can be used as a battery system installed on-board a vehicle. A vehicle with this power source apparatus on-board can be an electric-powered vehicle such as a hybrid car (hybrid vehicle, HV) or plug-in hybrid car that is driven by both an engine and an electric motor, or an electric automobile (electric vehicle, EV) that is driven only by an electric motor. The power source apparatus is used as a power source in these types of vehicles.

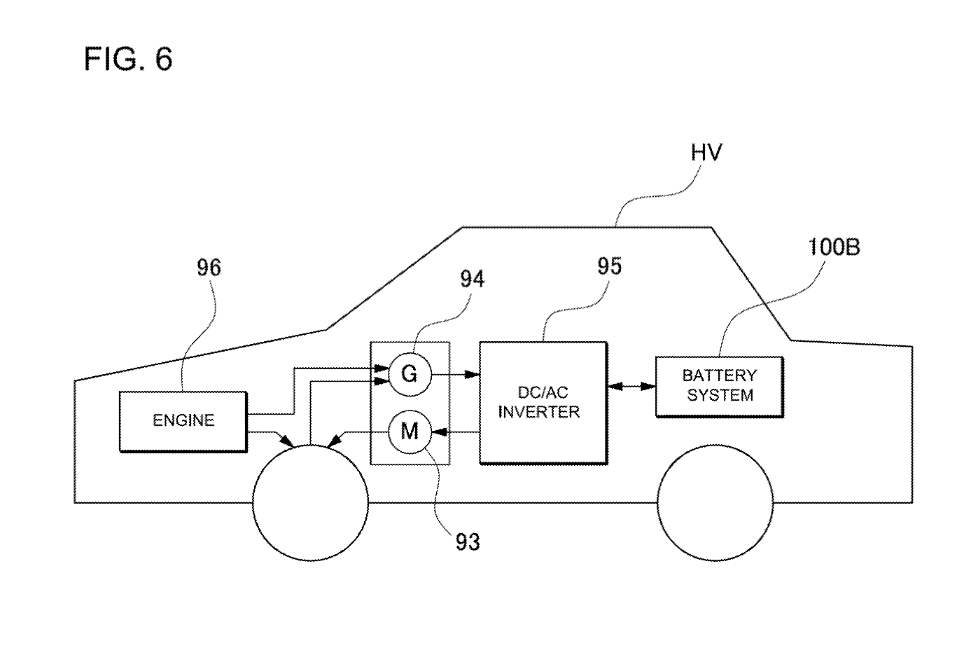

In FIG. 6, an example is shown of the power source apparatus installed on-board a hybrid car that is driven by both an engine and an electric motor. The vehicle HV with an on-board power source apparatus shown in this figure is provided with an engine 96 and a motor 93 that drive the vehicle HV, a battery system 100B that supplies power to the motor 93, and a generator 94 that charges the battery system 100B batteries. The battery system 100B is connected to the motor 93 and generator 94 via a DC/AC inverter 95. The vehicle HV is driven by both the motor 93 and the engine 96 while charging and discharging the battery system 100B batteries. The motor 93 is activated to drive the vehicle during inefficient modes of engine operation such as during acceleration and slow speed driving. The motor 93 is operated by power supplied from the battery system 100B. The generator 94 is driven by the engine 96 or by regenerative braking during vehicle deceleration to charge the battery system 100B batteries.

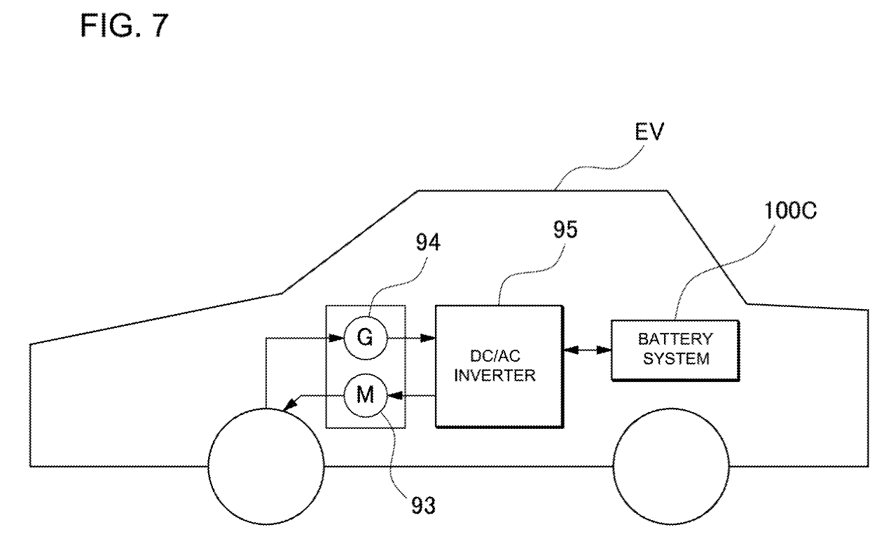

FIG. 7 shows and example of an electric vehicle driven only by an electric motor and having a battery system installed on-board. The vehicle EV shown in this figure is provided with a motor 93 that drives the vehicle EV, a battery system 100C that supplies power to the motor 93, and a generator 94 that charges the battery system 100C batteries. The motor 93 is operated by power supplied from the battery system 100C. The generator 94 is driven by energy from regenerative braking of the vehicle EV to charge the battery system 100C batteries.

The car power source apparatus, car with the power source apparatus installed, and capacity equalizing method for the car power source apparatus of the present invention can be used appropriately as a method of equalizing capacity in vehicles such as a plug-in hybrid electric vehicle that can switch between an electric vehicle (EV) mode and a hybrid electric vehicle (HEV) mode, a hybrid car (hybrid electric vehicle), and an electric automobile (electric vehicle).

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the spirit and scope of the invention as defined in the appended claims. The present application is based on Application No. 2009-222576 filed in Japan on Sep. 28, 2009, the content of which is incorporated herein by reference.

What is claimed is:

1. A car power source apparatus comprising:
a plurality of battery units having a plurality of series-connected battery cells;
a battery block having the plurality of battery units connected in parallel;
a unit switch connected in series with each battery unit;
cell voltage detection circuits that detect the cell voltages of the battery cells that make up the battery units;
cell capacity equalizing circuits that suppress remaining battery capacity variation between the battery cells that make up the battery units based on the cell voltages detected by the cell voltage detection circuits;
unit voltage detection circuits that detect unit voltages that are the total voltages of the battery units;
unit capacity equalizing circuits that suppress remaining battery capacity variation between battery units based on the unit voltages detected by the unit voltage detection circuits; and
a power source controller that controls the cell capacity equalizing circuits to equalize battery cell remaining capacities in each battery unit, and subsequently controls the unit capacity equalizing circuits to equalize battery unit remaining capacities over the entire battery block.

2. The car power source apparatus as cited in claim 1 wherein the power source controller can receive a start signal from the vehicle-side;
when the power source controller detects that start signal from the vehicle-side indicates an inactive state, all the unit switches are turned OFF and battery cells within the battery units are equalized by the cell capacity equalizing circuits.

3. The car power source apparatus as cited in claim 2 wherein the power source controller determines the necessity for equalization between battery cells in each battery unit based on battery cell voltages detected by the cell voltage detection circuits; for a battery unit judged to require equalization, the power source controller issues a cell remaining capacity equalization directive to the cell capacity equalizing circuit of the applicable battery unit to equalize the remaining capacities of the battery cells in that battery unit.

4. The car power source apparatus as cited in claim 3 wherein when the power source controller detects completion of cell remaining capacity equalization, the power source controller determines the necessity for equalization between battery units based on battery unit voltages detected by the unit voltage detection circuits; for battery units judged to require equalization, the power source controller issues unit remaining capacity equalization directives to the unit capacity equalizing circuits of the applicable battery units to equalize remaining battery capacities among the battery units.

5. The car power source apparatus as cited in claim 4 wherein the power source controller detects completion of cell remaining capacity equalization by receiving of an equalization-completed signal from the applicable battery unit.

6. The car power source apparatus as cited in claim 4 wherein the power source controller detects completion of cell remaining capacity equalization based on the battery cell voltages detected by the cell voltage detection circuit.

7. The car power source apparatus as cited in claim 4 wherein the power source controller detects completion of unit remaining capacity equalization based on the battery unit voltages detected by the unit voltage detection circuit for each battery unit.

8. The car power source apparatus as cited in claim 2 provided with battery block power output terminals, and an output switch connected between the power output terminals and the battery block; when the power source controller receives a key-OFF signal from the vehicle-side, the power source controller turns the output switch OFF and leaves the unit switches ON for a given time period; and the power source controller turns the unit switches OFF after the given time period.

9. The car power source apparatus as cited in claim 2 wherein the start signal is the key-ON signal.

10. The car power source apparatus as cited in claim 8 wherein the start signal is the key-ON signal.

11. A capacity equalizing method for the car power source apparatus comprising:
a plurality of battery units having a plurality of series-connected battery cells;
a battery block having the plurality of battery units connected in parallel;
cell voltage detection circuits that detect the cell voltages of the battery cells that make up the battery units;
unit switches connected in series with each battery unit;
unit voltage detection circuits that detect the overall unit voltages of the battery units;
cell capacity equalizing circuits that suppress remaining battery capacity variation between the battery cells that make up the battery units;
unit capacity equalizing circuits that suppress remaining battery capacity variation between battery units; and
a power source controller that can receive signals from the vehicle-side, controls the cell capacity equalizing circuits to equalize battery cell remaining capacities in each battery unit, and controls the unit capacity equalizing circuits to equalize battery unit remaining capacities over the entire battery block;
the method comprising:
a step to determine if the start signal from the vehicle-side indicates an inactive state;
a step to turn all the unit switches OFF when the start signal indicates an inactive state;
a step for the power source controller to determine if equalization of the battery cells is necessary in each battery unit based on battery cell voltages detected by the cell voltage detection circuits;
a step for applicable cell capacity equalizing circuits to equalize the remaining capacity of each battery cell within the applicable battery units when equalization is determined necessary;
a step for the power source controller to determine if cell remaining capacity equalization has been completed for all applicable battery units;
a step for the power source controller to determine if equalization between battery units is necessary based on battery unit voltages detected by the unit voltage detection circuits when completion of cell remaining capacity equalization is determined; and
a step for applicable unit capacity equalizing circuits to equalize remaining battery capacity between applicable battery units when equalization is determined necessary.

12. The capacity equalizing method for the car power source apparatus as cited in claim 11 that further includes a step when the power source controller receives a key-OFF signal from the vehicle-side, the power source controller turns OFF the output switch connected between the power output terminals and the battery block while leaving the unit switches in the ON state for a given time period, and subsequently turns the unit switches OFF after the given time interval.
